(19) United States
(12) Patent Application Publication
(10) Pub. No.: US 2010/0230836 A1
(43) Pub. Date: Sep. 16, 2010

(54) IMPRINT MOLD AND IMPRINT MOLDING METHOD

(75) Inventor: TAI-CHERNG YU, Tu-Cheng (TW)

Correspondence Address: Altis Law Group, Inc.;ATTN: Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/562,302

(22) Filed: Sep. 18, 2009

(30) Foreign Application Priority Data
Mar. 13, 2009 (CN) 200910300816.5

(51) Int. Cl. B29D 11/00; B29C 43/00

(52) U.S. Cl. 264/1.32; 425/471

(57) ABSTRACT

An exemplary imprint mold includes a surface, a plurality of molding portions arranged on the surface and a plurality of contraposition symbols arranged around the molding portions. The contraposition symbols include two first contraposition symbols arranged parallel to a first axis, two second contraposition symbols arranged parallel to a second axis, and four third contraposition symbols. The first axis and the second axis are perpendicularly intersecting at a geometrical center of the surface. Any two selected of the four third contraposition symbols are symmetrically positioned relative to each other about one of the first axis, the second axis, and the geometrical center.

### BACKGROUND

1. Technical Field

The present disclosure relates to imprint molds and methods, and particularly, to an imprint mold for imprinting optical elements such as optical lenses.

2. Description of Related Art

Imprint technology is a simple process with low cost, high throughput and high resolution. Imprint technology has been used for making optical elements such as lenses.

In a typical imprinting process for making a lens array, double-sided imprinting or stack imprinting is performed. In either case, when a second imprinting is performed on a substrate after a first imprinting, the position of the substrate is liable to have shifted between the first imprinting and the second imprinting. Thus the dimensional precision of the lens array may be greatly reduced.

Therefore, what are needed are an imprint mold and an imprinting method which can overcome the above-described shortcomings.

### BRIEF DESCRIPTION OF THE DRAWINGS

Many aspects of the present imprint mold and imprinting method can be better understood with reference to the following drawings. The components in the drawings are not necessarily to scale, the emphasis instead being placed upon clearly illustrating the principles of the present imprint mold and imprinting method. Moreover, in the drawings, all the views are schematic, and like reference numerals designate corresponding parts throughout the several views.

FIG. 1 is a bottom plan view of an imprint mold in accordance with a first embodiment, the imprint mold having a plurality of molding portions and contraposition symbols.

FIG. 2 is a bottom plan view of an imprint mold in accordance with a second embodiment.

FIG. 3 is a bottom plan view of an imprint mold in accordance with a third embodiment.

FIG. 4 is a top plan view of a substrate having a lens array and a plurality of contraposition symbols thereon which have been imprinted by the imprint mold of FIG. 1.

FIG. 5 is a cross-sectional view of the substrate of FIG. 4, taken along a line V-V thereof.

FIG. 6 is similar to FIG. 5, but showing a transparent material layer formed on an underside of the substrate, the transparent material layer being ready to be imprinted.

### DETAILED DESCRIPTION

Reference will now be made to the drawings to describe in detail various exemplary embodiments of the present imprint mold and imprinting method.

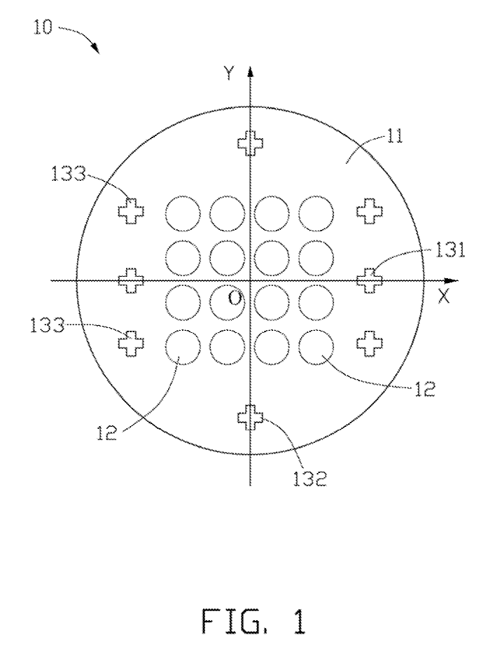

Referring to FIG. 1, an imprint mold 10, in accordance with a first embodiment, is used for imprinting lenses. The imprint mold 10 is circular, and is made from a material selected from the group consisting of silicon and rigid metal. Such material can for example be tungsten carbide (WC), silicon carbide (SiC), silicon nitride (Si₃N₄), titanium carbide (TiC), etc. The size of the imprint mold 10 is substantially the same as a size of a substrate which is to be imprinted. For example, the imprint mold 10 can be a four inch imprint mold, a six inch imprint mold, an eight inch imprint mold, or a twelve inch imprint mold.

The imprint mold 10 has a surface 11, a plurality of molding portions 12 arranged in an array on the surface 11, and eight contraposition symbols arranged around the plurality of molding portions 12. The eight contraposition symbols include two first contraposition symbols 131, two second contraposition symbols 132, and four third contraposition symbols 133. The molding portions 12 are capable of imprinting spherical lenses or aspheric lenses. The shape of the molding portions 12 can be determined according to the desired shape of the lenses.

The two first contraposition symbols 131 are arranged on an X coordinate axis, and the two second contraposition symbols 132 are arranged on a Y coordinate axis. The intersection point of the X coordinate axis and the Y coordinate axis is the geometrical center O of the surface 11. The four third contraposition symbols 133 are respectively arranged on four quadrants of the surface 11 defined by the X-Y coordinate axes. Each third contraposition symbol 133 is symmetrically opposite a first other third contraposition symbol 133 about the X coordinate axis, is symmetrically opposite a second other third contraposition symbol 133 about the Y coordinate axis, and is diagonally opposite a third other third contraposition symbol 133 about the geometrical center O. The shapes of the first, the second and the third contraposition symbols 131, 132, 133 can be the same, or can be different from each other. In the present embodiment, each of the contraposition symbols 131, 132, 133 is cross-shaped.

When the imprint mold 10 is used to imprint a substrate, the first contraposition symbols 131 are transfer printed to the substrate, and the transfer printed contraposition symbols are capable of adjusting contraposition errors along directions of an X coordinate axis of the substrate. The second contraposition symbols 132 are transfer printed to the substrate, and the transfer printed contraposition symbols are capable of adjusting contraposition errors along directions of a Y coordinate axis of the substrate. The third contraposition symbols 133 are transfer printed to the substrate, and the transfer printed contraposition symbols are capable of adjusting contraposition errors along directions other than the X coordinate axis directions and the Y coordinate axis directions.

In use of the imprint mold 10, the first, the second, and the third contraposition symbols 131, 132, 133 are correspondingly transfer printed to a substrate in a first imprinting process. Then in a successive imprinting process, for example a second imprinting process, any one or more of the first, the second and the third contraposition symbols 131, 132, 133 already transfer printed on the substrate can be aligned with corresponding contraposition symbols of an imprint mold used in the second imprinting process. Thus the second imprinting process can be performed with high accuracy.

It is understood that the first, the second and the third contraposition symbols 131, 132, 133 can instead be “I”-shaped, “E”-shaped, or “F”-shaped, or have any of various other suitable shapes.

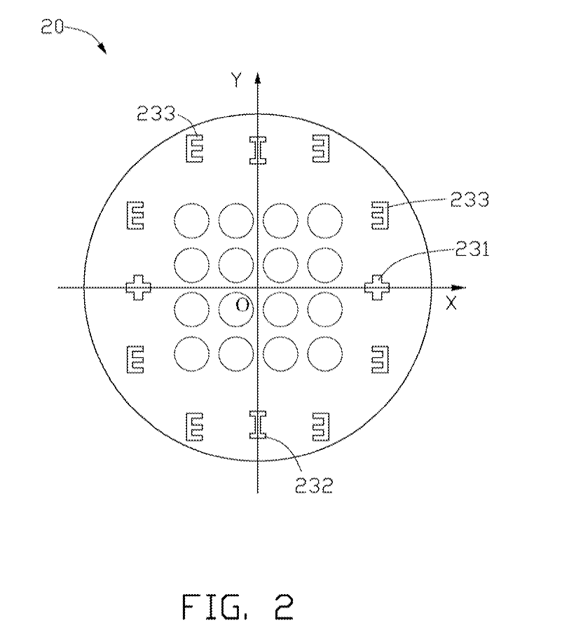

Referring to FIG. 2, an imprint mold 20, in accordance with a second embodiment, is similar to the imprint mold 10 of the first embodiment. However, the imprint mold 20 has eight third contraposition symbols 233. In addition, first contraposition symbols 231, second contraposition symbols 232, and the third contraposition symbols 233 have different shapes from one another. The first contraposition symbols 231 are cross-shaped. The second contraposition symbols 232 are “I”-shaped. The third contraposition symbols 233 are “E”-shaped, with the open side of every “E”-shape facing toward a Y coordinate axis.

It is understood that in alternative embodiments, the open side of every “E”-shape can face toward an X coordinate axis, or face directly toward a geometrical center O of a first surface (not labeled) of the imprint mold 20, or face diametrically away from the geometrical center O.

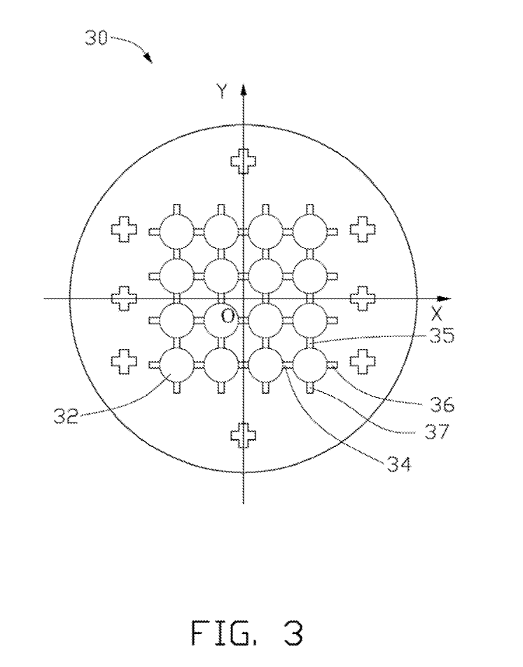

Referring to FIG. 3, an imprint mold 30, in accordance with a third embodiment, is similar to the imprint mold 10 of the first embodiment. However, each of molding portions 32 has four grooves extending outward therefrom. The four grooves are a first groove 34, a second groove 35, a third groove 36, and a fourth groove 37. When any such groove 34, 35, 36, 37 extends toward an adjacent molding portion 32, the two adjacent molding portions 32 share that same groove 34, 35, 36, 37. The first grooves 34 and the third grooves 36 are arranged parallel to an X coordinate axis, and the second grooves 35 and the fourth grooves 37 are arranged parallel to a Y coordinate axis.

The grooves 34, 35, 36, 37 have the following functions. Firstly, the grooves 34, 35, 36, 37 can release air that might otherwise be trapped in the molding portions 32, thus avoiding air bubbles being formed in the molding portions 32. Secondly, during imprinting, if too much optical material fills the molding portions 32 of the imprint mold 30, the excess optical material can flow out from the imprint mold 30 via the grooves 34, 35, 36, 37 and/or remain in the grooves 34, 35, 36, 37. Thereby, optical lenses having the correct thickness and configuration can still be imprinted by the imprint mold 30.

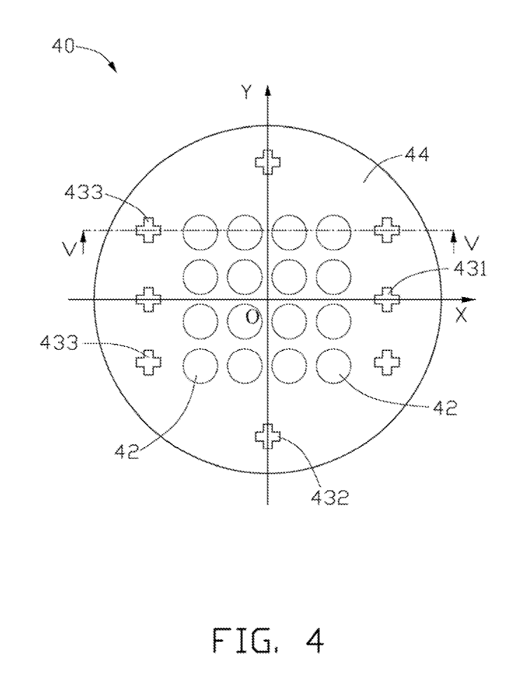

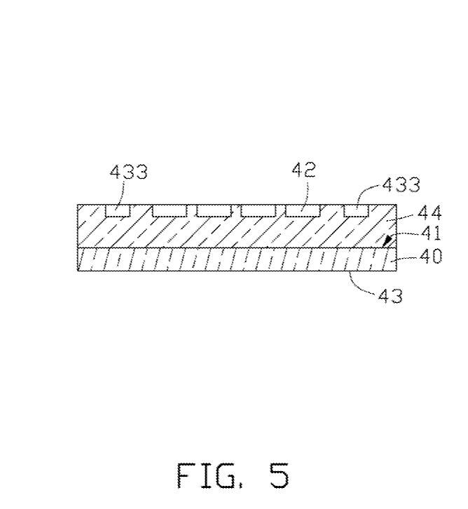

Referring to FIGS. 4 and 5, in producing lenses on a first (top) surface 41 of a substrate 40 using the imprint mold 10, firstly, a first transparent material layer 44 is distributed on the first surface 41. Then the first contraposition symbols 131, the second contraposition symbols 132 and the third contraposition symbols 133 are transfer printed to the first surface 41 by the imprint mold 10. Thus, a plurality of lenses 42 arranged in an array, together with corresponding contraposition symbols, are formed on the substrate 40. The corresponding contraposition symbols are fourth contraposition symbols 431, fifth contraposition symbols 432, and sixth contraposition symbols 433. The positions of the lenses 42 correspond to the positions of the molding portions 12. The positions of the fourth contraposition symbols 431, the fifth contraposition symbols 432, and the sixth contraposition symbols 433 respectively correspond to the positions of the first contraposition symbols 131, the second contraposition symbols 132, and the third contraposition symbols 133. The substrate 40 is made from transparent material, such as glass or silicon. In the present embodiment, the substrate 40 is made from silicon.

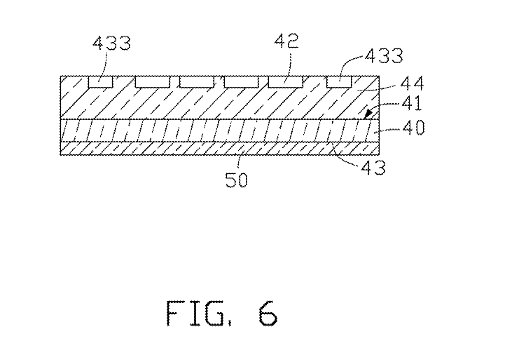

Referring also to FIG. 6, a second transparent material layer 50 is formed on a second (bottom) surface 43 of the substrate 40. The first and the second transparent material layers 44, 50 are made from material selected from polydimethyl siloxane, photosensitive resin, and polymethyl methacrylate.

Because the substrate 40 and the second transparent material layer 50 are both transparent, the lenses 42, the fourth contraposition symbols 431, the fifth contraposition symbols 432 and the sixth contraposition symbols 433 on the first surface 41 can be seen from the second surface 43.

In imprinting the second transparent material layer 50 using the imprint mold 10, the first, the second and the third contraposition symbols 131, 132, 133 of the imprint mold 10 are aligned with the corresponding fourth, fifth and sixth contraposition symbols 431, 432, 433 on the first surface 41. Thus, the molding portions 12 are aligned with the lenses 42, and the lenses (not shown) which are imprinted on the second transparent material layer 50 can be accurately aligned with the lenses 42. That is, each pair of lenses at the two opposite surfaces 41, 43 of the silicon substrate 40 can be accurately aligned with each other. Accordingly, physical and optical aberrations such as the eccentric phenomena can be reduced or even eliminated altogether.

While the present invention has been described as having preferred or exemplary embodiments, the embodiments can be modified within the spirit and scope of this disclosure. This application is therefore intended to cover any variations, uses, or adaptations of the embodiments using the general principles of the invention as claimed. Further, this application is intended to cover such departures from the present disclosure as come within known or customary practice in the art to which the invention pertains and which fall within the limits of the appended claims or equivalents thereof.

What is claimed is:

1. An imprint mold, comprising:
a surface;
a plurality of molding portions arranged on the surface; and
a plurality of contraposition symbols arranged around the molding portions, the contraposition symbols comprising two first contraposition symbols arranged parallel to a first axis, two second contraposition symbols arranged parallel to a second axis, and four third contraposition symbols, the first axis and the second axis perpendicularly intersecting at a geometrical center of the surface, any two selected of the four third contraposition symbols being symmetrically positioned relative to each other about one of the first axis, the second axis, and the geometrical center.

2. The imprint mold of claim 1, wherein the third contraposition symbols are symmetrically arranged about the first axis.

3. The imprint mold of claim 1, wherein the third contraposition symbols are symmetrically arranged about the second axis.

4. The imprint mold of claim 1, wherein the two first contraposition symbols are symmetrically arranged about the second axis and the two second contraposition symbols are symmetrically arranged about the first axis.

5. The imprint mold of claim 1, wherein a groove is formed in the surface between each two adjacent molding portions.

6. The imprint mold of claim 5, wherein each molding portion has four grooves extending from a periphery thereof, with two of the grooves arranged in a first line and the other two grooves arranged in a second line.

7. The imprint mold of claim 1, wherein each of the first contraposition symbols, the second contraposition symbols and the third contraposition symbols is selected from the group consisting of cross-shaped, “I”-shaped, “E”-shaped and “F”-shaped.

8. The imprint mold of claim 1, wherein the imprint mold contains material selected from the group consisting of silicon, tungsten carbide, silicon carbide, silicon nitride and titanium carbide.

9. A method for imprinting a plurality of lenses, the method comprising:
providing an imprint mold comprising a plurality of molding portions and a plurality of contraposition symbols arranged at a same surface of the imprint mold, the contraposition symbols comprising two first contraposition symbols arranged parallel to a first axis, two second contraposition symbols arranged parallel to a second axis, and four third contraposition symbols, the first axis and the second axis perpendicularly intersecting at a geometrical center of the surface, any two selected of the four third contraposition symbols being symmetrically positioned relative to each other about one of the first axis, the second axis, and the geometrical center;
providing a transparent substrate, the substrate having a first surface and a second surface at opposite sides thereof;
forming a first transparent material layer on the first surface of the substrate;
imprinting the first transparent material layer using the imprint mold, thereby forming a first lens array and two fourth contraposition symbols, two fifth contraposition symbols, and four sixth contraposition symbols, the fourth, fifth and sixth contraposition symbols corresponding to the first, second and third contraposition symbols, respectively;
forming a second transparent material layer on the second surface of the substrate; and
imprinting the second transparent material layer using the imprint mold, by aligning the first, second and third contraposition symbols with the corresponding fourth, fifth and sixth contraposition symbols, thus obtaining a second lens array aligned with the first lens array.

10. The method of claim 9, wherein the imprint mold contains material selected from the group consisting of silicon, tungsten carbide, silicon carbide, silicon nitride and titanium carbide.

11. The method of claim 9, wherein the transparent substrate is made from silicon or glass.

12. The method of claim 9, wherein each of the first and the second transparent material layers contains material selected from the group consisting of polydimethyl siloxane, photosensitive resin, and polymethyl methacrylate.

13. The method of claim 9, wherein each of the first contraposition symbols, the second contraposition symbols and the third contraposition symbols is selected from the group consisting of cross-shaped, “I”-shaped, “E”-shaped and “F”-shaped.

14. The method of claim 9, wherein the two first contraposition symbols are symmetrically arranged about the second axis and the two second contraposition symbols are symmetrically arranged about the first axis.

15. The method of claim 9, wherein each molding portion comprises four grooves extending outward to an adjacent molding portion.
